(19) United States
(12) Patent Application Publication
(10) Pub. No.: US 2008/0150904 A1
(43) Pub. Date: Jun. 26, 2008

(54) Touch scroll mouse with orientation sensation

(76) Inventors: Yen-Chang Chiu, Linkou Township (TW); Jia-Yih Lii, Taichung City (TW); Tso-Chieh Yang, Chingshuei Townsh (TW); Chen-Yao Yang, Chingshuei Townsh (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/643,852

(22) Filed: Dec. 22, 2006

(51) Int. Cl. G06F 3/041

(52) U.S. Cl. 345/173

(57) ABSTRACT

A touch scroll mouse with orientation sensation comprises a touchpad providing a scroll bar function. The touchpad comprising a plurality of orientation structures, these orientation structures including barriers, protuberant or concave lump structures, protuberant transverse structures or transverse nicks, supplying the users to tell if their finger touch the auto-scrolling regions or determine their slide distance and direction.

### FIELD OF THE INVENTION

The present invention is related generally to a computer mouse and, more particularly, to a touch scroll mouse.

### BACKGROUND OF THE INVENTION

The structure of computer mouse was constantly be improved to make the users feel more convenient or provide more functions, therefore, produced the touch scroll mouse 10 as shown in FIG. 1, in which a mouse body 12 was for user holding and providing the base functions of computer mouse, such as the function of cursor moving or target choosing, the touchpad 14 is set on the mouse body 12. Referring to the FIG. 2, there are four arrows 145 printed or laser etched on the touchpad 14 to mark the directions of scroll. When user's finger slid up and down, the vertical direction scroll was rolled, and the scroll of horizontal direction was rolled when user's finger slid left and right. Furthermore, there are four auto-scrolling regions 16 on the touchpad 14. The auto-scrolling region 16 is an area defined by a designer, usually on the edge of each direction. When the user's finger touches the auto-scrolling region 16 of one direction, an auto-scrolling function will be start and makes the scroll keep rolling to the direction.

However, because of the arrows 145 are printed on the touchpad 14, they do not have structures to provide senses of touch. Referring to FIG. 2, the surface of touchpad 14 was flat. Under the situation of no sense of touch, if the users did not look at the touchpad when using touch scroll mouse, they were hard to tell the slide distance and do they touch the auto-scrolling region 16 or not. Otherwise, the way of the users holding the mouse body 12 also causes the users' finger slide to incorrect direction. To overcome these problems, the conventional touch scroll mouse would provide the simulating sound of scroll rolling to make the users know that how long did they slide. However, the problems of slide direction or how to tell the auto-scrolling region 16 are still not solved, and thus the users have to judge it on their own after long-term using.

Therefore, it is desired a touch scroll mouse with orientation sense of touch.

### SUMMARY OF THE INVENTION

An object of the present invention is to provide a touch scroll mouse with orientation sense of touch.

According to the present invention, a touch scroll mouse with orientation sense of touch comprises a touchpad with a plurality of orientation structures such as barriers, protuberant or concave structures, protuberant transverse structures or transverse nicks supplying the users to tell if the finger touch the auto-scrolling regions or determine their slide distance and direction.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional touch scroll mouse;

FIG. 2 is the touchpad of the touch scroll mouse in FIG. 1;

FIG. 3 is the first embodiment of the present invention;

FIG. 4 is the second embodiment of the present invention;

FIG. 5 is the third embodiment of the present invention;

FIG. 6 is the forth embodiment of the present invention;

FIG. 7 is the fifth embodiment of the present invention;

FIG. 8 is the sixth embodiment of the present invention; and

FIG. 9 is the seventh embodiment of the present invention.

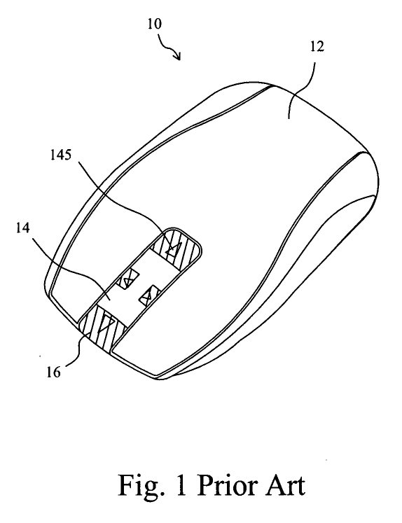

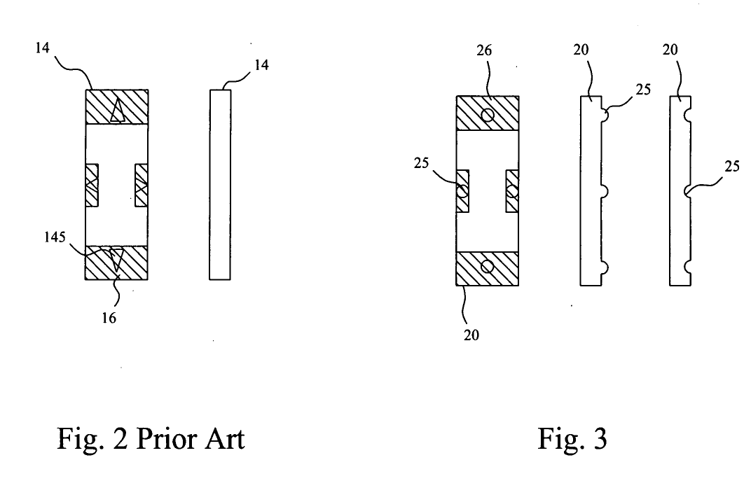

### DETAILED DESCRIPTION OF THE INVENTION

FIG. 3 is the first embodiment of the present invention. There were four areas on the touchpad 20 each was defined as an auto-scrolling region 26 on the edge of each direction. The orientation structure 25 was inside the auto-scrolling region 26 which has a protuberant or concave circular structure. When the user's finger touches the orientation structure 25, the user gets a sense of touch to know that he has touched the auto-scrolling region 26. In other embodiments, the orientation structure 25 could be square structure or other shapes.

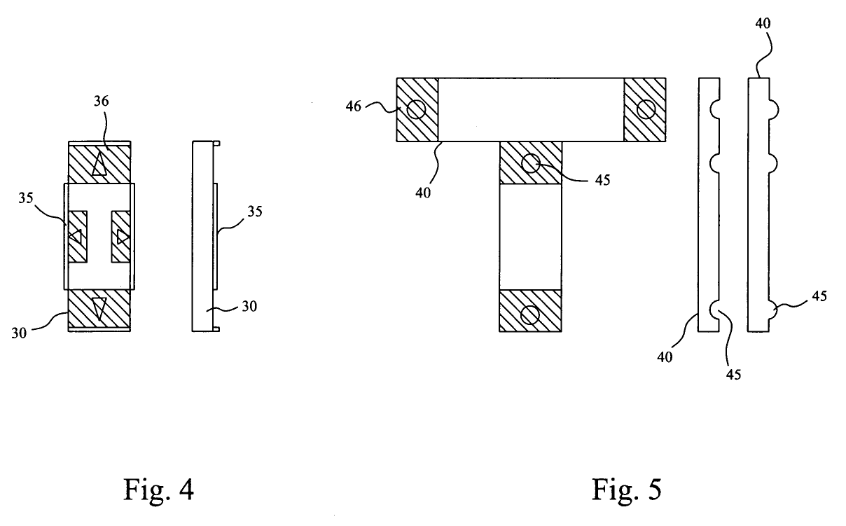

FIG. 4 is the second embodiment of the present invention. There were four barriers 35 set on the touchpad 30 each was on the edge of four direction of the touchpad 30. When the user's finger touches the barrier 35, the user gets a sense of touch to know that he has touched the auto-scrolling region 36.

FIG. 5 is the third embodiment of the present invention. The touchpad 40 was a T-shape touchpad and four areas on the edge of each direction were defined as the auto-scrolling region 46. The orientation structure 45 was inside the auto-scrolling region 46 which has a protuberant or concave circular structure. When the user's finger touches the barrier 45, the user gets a sense of touch to know that he has touched the auto-scrolling region 46.

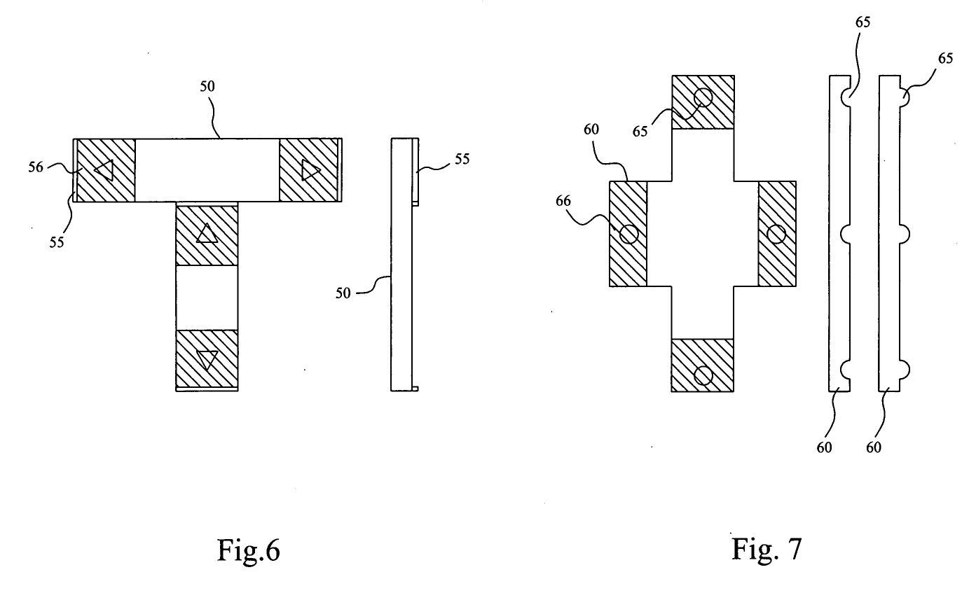

FIG. 6 is the forth embodiment of the present invention. The touchpad 50 was a T-shape touchpad and has four barriers 55 set on it. The areas of the edge of each direction were defined as the auto-scrolling region 56. When the user's finger touches the barrier 55, the user gets a sense of touch to know that he has touched the auto-scrolling region 56.

FIG. 7 is the fifth embodiment of the present invention. There are four areas on the edge of each direction on the crisscross touchpad 60 be defined as the auto-scrolling regions 66. The orientation structure 65 was inside the auto-scrolling region 66 which has a protuberant or concave circular structure. When the user's finger touches the orientation structure 65, the user gets a sense of touch to know that he has touched the auto-scrolling region 66.

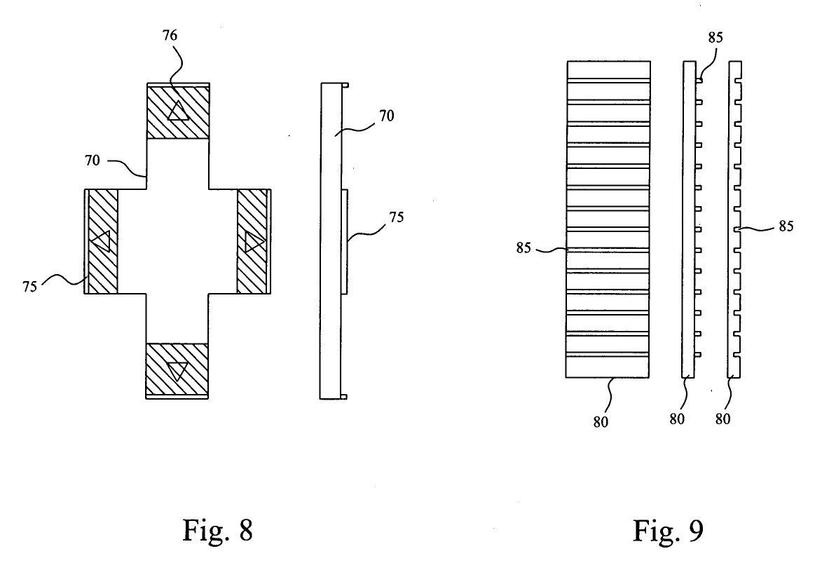

FIG. 8 is the sixth embodiment of the present invention. The crisscross touchpad 70 has four barriers 75 set on the edge of each direction. The four areas on the edge of each direction were defined as the auto-scrolling region 76. When the user's finger touches the barrier 75, the user gets a sense of touch to know that he has touched the auto-scrolling region 76.

FIG. 9 is the seventh embodiment of the present invention. A row of orientation structure 85 set on the touchpad 80. The orientation structures 85 are protuberant transverse structures or transverse nicks. When the user's finger slide on the touchpad 80, these orientation structures 85 help the user determine the slide direction and provide a sense of slide distance.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set fourth in the appended claims.

What is claimed is:

1. A touch scroll mouse with orientation sensation, comprising:
a mouse body; and
a touchpad, set on the mouse body to provide a scroll bar function, the touchpad has a plurality of auto-scrolling regions and orientation structures, these orientation structures are supplying the users to tell if their finger touch the auto-scrolling region or not.

2. The touch scroll mouse of claim 1, wherein the orientation structure comprises a barrier set on the edge of the touchpad.

3. The touch scroll mouse of claim 1, wherein the orientation structure comprises a protuberant structure.

4. The touch scroll mouse of claim 1, wherein the orientation structure comprises a concave structure.

5. A touch scroll mouse with orientation sensation, comprising:
a mouse body; and
a touchpad, set on the mouse body to provide a scroll bar function, the touchpad has a plurality of orientation structures supplying the users to determine their slide distance and direction.

6. The touch scroll mouse of claim 5, wherein the orientation structure comprises a protuberant transverse structure.

7. The touch scroll mouse of claim 5, wherein the orientation structure comprises a transverse nicks.
